(19) United States
(12) Patent Application Publication
(10) Pub. No.: US 2015/0275062 A1
(43) Pub. Date: Oct. 1, 2015

(54) THERMALLY CONDUCTIVE COMPOSITION AND SHEET

(71) Applicant: LMS CO., LTD, Gyeonggi-do (KR)

(72) Inventors: Byeong Cheol Kim, Gyeonggi-do (KR); Doo Hyo Kwon, Gyeonggi-do (KR); Oh Kwan Kwon, Gyeonggi-do (KR); Jeong Og Choi, Seoul (KR)

(73) Assignee: LMS Co., Ltd., Gyeonggi-do (KR)

(21) Appl. No.: 14/433,653

(22) PCT Filed: Oct. 1, 2013
(86) PCT No.: PCT/KR2013/008786

§ 371 Date: Apr. 4, 2015

(30) Foreign Application Priority Data
Oct. 5, 2012 (KR) 10-2012-0110603

(51) Int. Cl. C09K 5/14

(52) U.S. Cl. CPC C09K 5/14

(57) ABSTRACT

A thermally conductive composition according to the present invention includes a base resin, thermally conductive particles, and a carbon-containing powder. Accordingly, heat transfer characteristics of a sheet may be improved.

### CROSS-REFERENCE TO RELATED APPLICATIONS

This application is the United States national phase of International Application No. PCT/KR2013/008786 filed Oct. 1, 2013, and claims priority to Korean Patent Application No. 10-2012-0110603 filed Oct. 5, 2012, the disclosure of which are hereby incorporated in their entirety by reference.

### TECHNICAL FIELD

The present invention relates to a thermally conductive composition and sheet, and more particularly, to a thermally conductive composition by which a sheet having improved heat transfer characteristics is manufactured, and a sheet.

### BACKGROUND ART

In general, an electronic product includes various kinds of electronic devices from which heat is generated while the product is driven. Since the electronic product has a problem such as malfunction due to heat generated from the electronic devices, heat radiation sheets are introduced into the electronic product in order to emit heat generated from the electronic devices.

In the related art, heat generated from the electronic devices was emitted by using a metal heat radiation sheet composed of a metal having high heat conductivity, such as aluminum (Al) or copper (Cu), but there was a problem in that heat transfer characteristics deteriorate as the thickness of the metal heat radiation sheet became small. Further, there is also a disadvantage in that production costs are increased by a high temperature process of manufacturing a metal heat radiation sheet, thereby leading to an increase in unit cost of the heat radiation sheet.

Meanwhile, heat radiation sheets using graphene having excellent heat transfer characteristics, which replaces metal, have been developed. Since graphene has a plate-like structure, a heat radiation sheet using graphene has low heat transfer characteristics in a direction perpendicular to an in-plane direction of graphene compared to heat transfer characteristics of graphene in the in-plane direction thereof. Accordingly, there is a limitation in manufacturing a heat radiation sheet having excellent heat transfer characteristics both in the in-plane direction and in the direction perpendicular to the in-plane direction even though graphene is used.

### DISCLOSURE

### Technical Problem

The present invention provides a composition having improved heat transfer characteristics.

The present invention provides a thermally conductive sheet manufactured by using the composition.

### Technical Solution

A composition according to an exemplary embodiment of the present invention includes a base resin, thermally conductive particles distributed in the base resin, and a carbon-containing powder distributed in the base resin.

The thermally conductive particles may include a core and a metal layer coated on the surface of the core.

The metal layer may include a single layer or a plurality of layers. The metal layer may include at least one of gold (Au), silver (Ag), a nickel-phosphorus alloy (Ni—P alloy), a nickel-boron alloy (Ni—B alloy), beryllium (Be), chromium (Cr), zirconium (Zr), copper (Cu), cobalt (Co), aluminum (Al), magnesium (Mg), rhodium (Rh), zinc (Zn), tantalum (Ta), iron (Fe), titanium (Ti), platinum (Pt), tungsten (W), molybdenum (Mo), manganese (Mn), iridium (Ir), and tin (Sn). The metal layer may have a thickness of 50 nm to 3 μm. Further, the content of the metal layer may be 0.5 to 70 wt % with respect to the total weight of the core and the metal layer.

The core may include a polymer. Here, the core may have a diameter of 300 nm to 30 μm.

The base resin may include at least one selected from an ethylene resin, a propylene resin, a vinyl chloride resin, a styrene resin, a carbonate resin, an ester resin, a nylon resin, a silicone resin, and an imide resin.

The carbon-containing powder may include at least one of carbon nanotubes, graphene flake, oxidized graphene flake, graphite flake, expanded graphite flake, oxidized graphite flake, fullerene, carbon fiber, and carbon black. The graphene flake may have a specific surface area of 50 m²/g to 2,675 m²/g. In this case, the content of the thermally conductive particles may be 1 to 30 wt % with respect to the total weight of the composition. In addition, the content of the carbon-containing powder may be 1 to 30 wt % with respect to the total weight of the composition.

A sheet according to an exemplary embodiment of the present invention is a sheet which conducts heat, and includes a base film, thermally conductive particles distributed in the base film, and a carbon-containing powder distributed in the base film.

The thermally conductive particles may include particles in which the surface of a core is coated with a metal layer. In this case, at least a part of the thermally conductive particles may be brought into contact with the carbon-containing powder.

The metal layer may include a single layer or a plurality of layers. Here, the metal layer may include at least one of gold (Au), silver (Ag), a nickel-phosphorus alloy (Ni—P alloy), a nickel-boron alloy (Ni—B alloy), beryllium (Be), chromium (Cr), zirconium (Zr), copper (Cu), cobalt (Co), aluminum (Al), magnesium (Mg), rhodium (Rh), zinc (Zn), tantalum (Ta), iron (Fe), titanium (Ti), platinum (Pt), tungsten (W), molybdenum (Mo), manganese (Mn), iridium (Ir), and tin (Sn). The plurality of layers may include layers including metals different from each other. The metal layer may have a thickness of 50 nm to 3 μm.

With respect to the total weight of the core and the metal layer, the content of the metal layer may be 0.5 wt % to 70 wt %. The core may include a polymer, be spherical, and may have a diameter of 300 nm to 30 μm. In this case, the polymer may include at least one of polystyrene, polymethyl methacrylate, and an amino resin.

The base film may include at least one of an ethylene resin, a propylene resin, a vinyl chloride resin, a styrene resin, a carbonate resin, an ester resin, a nylon resin, a silicone resin, and an imide resin.

The carbon-containing powder may include at least one of carbon nanotubes, graphene flake, oxidized graphene flake, graphite flake, expanded graphite flake, oxidized graphite flake, fullerene, carbon fiber, and carbon black. The graphene flake may include graphene including at least one layer or more.

The content of the thermally conductive particles may be 1 to 30 wt % with respect to the total weight of the sheet, and the content of the carbon-containing powder may be 1 to 30 wt % with respect to the total weight of the sheet. The sheet may have heat conductivity of 3 W/mK to 50 W/mK in a direction perpendicular to an in-plane direction.

### Advantageous Effects

According to an exemplary embodiment of the present invention, it is possible to improve heat transfer characteristics of a sheet in an in-plane direction as well as in a direction perpendicular to the in-plane direction by manufacturing a composition and/or a sheet using both thermally conductive particles and a carbon-containing powder. Accordingly, since a separate sheet for strengthening heat transfer characteristics need not be used, the weight of a device may be reduced.

As described above, the sheet having improved heat transfer characteristics may be used in various electronic devices and electronic instruments, thereby improving heat emission characteristics of the electronic device and the electronic instrument, and improving reliability of the device and the instrument and extending a service life thereof therefrom. Furthermore, due to weight reduction of a sheet, it is also possible to reduce the weight of the device and the instrument to which the sheet is applied.

### DESCRIPTION OF DRAWINGS

FIG. 1 is a view illustrating a sheet according to the Example of the present invention.

FIG. 2 is a view illustrating thermally conductive particles according to an exemplary embodiment of the present invention.

FIG. 3 is a view illustrating a sheet according to the modified Example of the present invention.

FIG. 4 is a view sequentially illustrating a method for manufacturing a thermally conductive particle according to an exemplary embodiment of the present invention.

FIG. 5 is a view for describing a method for manufacturing a sheet according to the Examples of the present invention.

### BEST MODE

Hereinafter, a composition according to an exemplary embodiment of the present invention will be first described, and a sheet according to an exemplary embodiment of the present invention and a manufacturing method thereof will be described in more detail with reference to the accompanying drawings. However, the present invention is not limited to the Examples to be disclosed below, but may be implemented in various other forms, and the present Examples are provided for rendering the disclosure of the present invention complete and for fully representing the scope of the present invention to those skilled in the art. Like reference numerals in the drawings denote like elements.

A composition according to an exemplary embodiment of the present invention includes a base resin, thermally conductive particles, and a carbon-containing powder. The thermally conductive particles and the carbon-containing powder are distributed in the base resin. The composition may further include a cross-linker and a solvent.

The base resin may be dissolved in the solvent, and the composition may be in a liquid state by dissolving the base resin in the solvent. That is, the thermally conductive particles and the carbon-containing powder may be distributed in the base resin dissolved in the solvent. In a drying process of evaporating the solvent by adding heat to the composition, the base resin becomes a solid state. When the composition further includes a cross-linker, the cross-linker may be thermally reacted in the drying process to cross-link the base resin, thereby forming a cured product in a solid state.

Specific examples of the base resin include an ethylene resin, a propylene resin, a vinyl chloride resin, a styrene resin, a carbonate resin, an ester resin, a nylon resin, a silicone resin or an imide resin, and the like. These may be used either alone or in mixture of two or more thereof. The base resin may have a weight average molecular weight of about 100,000 to about 1,000,000 in consideration of solubility with respect to the solvent.

The content of the base resin may be about 30 wt % to about 65 wt % with respect to the total weight of the composition. For example, when the content of the base resin is less than about 30 wt %, it is difficult to form a sheet or a thin film because the content of a main material which determines the shape of an object is insufficient. Further, when the content of the base resin exceeds about 65 wt %, it is difficult to uniformly disperse the thermally conductive particles and the carbon-containing powder in the base resin because it is difficult to dissolve the base resin in the solvent.

The carbon-containing powder is a structural body formed of a carbon-based material. The carbon-containing powder may include particles having various shapes, such as spherical particles, plate-like particles, and wire-like particles (or tubular particles). Specific examples of the carbon-containing powder include carbon nanotubes, graphene flake, graphite flake, oxidized graphene flake, expanded graphite flake, oxidized graphite flake, fullerene, carbon black or carbon fiber, and the like. These may be used either alone or in combination of two or more thereof.

For example, the carbon nanotubes are a tubular powder elongated in one direction, and the thermal conductivity of carbon nanotubes in the elongated direction thereof may be about 3,000 W/mK to about 3,500 W/mK.

Graphene flake is a plate-like structural body including graphene having a two-dimensional planar structure in which six carbon atoms are connected in a honeycomb-like hexagonal form. The thermal conductivity of graphene is about 5,300 W/mK.

In the present invention, the “graphene flake” is defined as a powder having a graphene laminated structure including one to fifty layers. The graphene flake includes at least one layer of graphene. That is, the graphene flake may have a single-layered structure composed of one-layered graphene, or a multi-layered structure including two or more layers of graphene. The graphene flake may have a specific surface area of about 50 m²/g to about 2,675 m²/g. The “specific surface area” means a surface area of graphene flake per unit mass.

Graphite flake also has a structure in which a plurality of graphenes is laminated, is a powder having a structure in which the number of graphene laminated is larger than that in the graphene flake, and is defined as a powder which is differentiated from the graphene flake. The graphite flake has a specific surface area of a value larger than about 0 m²/g, and the value may be less than about 50 m²/g.

Oxidized graphene flake is a plate-like structural body including oxidized graphene. The oxidized graphene may be defined as a graphene in which a function group including an oxygen atom is bonded to the surface or edge thereof. The oxidized graphene flake includes oxidized graphene including at least one layer or more, and may further include graphene. In the oxidized graphene flake, the total number of layers of graphene and oxidized graphene may be fifty layers or less. That is, the oxidized graphene flake may be composed of oxidized graphene including 1 to 50 layers, or composed of graphene and oxidized graphene including at least one layer or more.

Further, the oxidized graphite flake includes oxidized graphene, and is a powder in which the total number of layers laminated is larger than that in the oxidized graphene flake. The oxidized graphite flake may be composed of oxidized graphene, or composed of oxidized graphene and graphene.

Expanded graphite flake is defined as a laminated structural body in which the distance between graphenes is larger than that in the graphite flake.

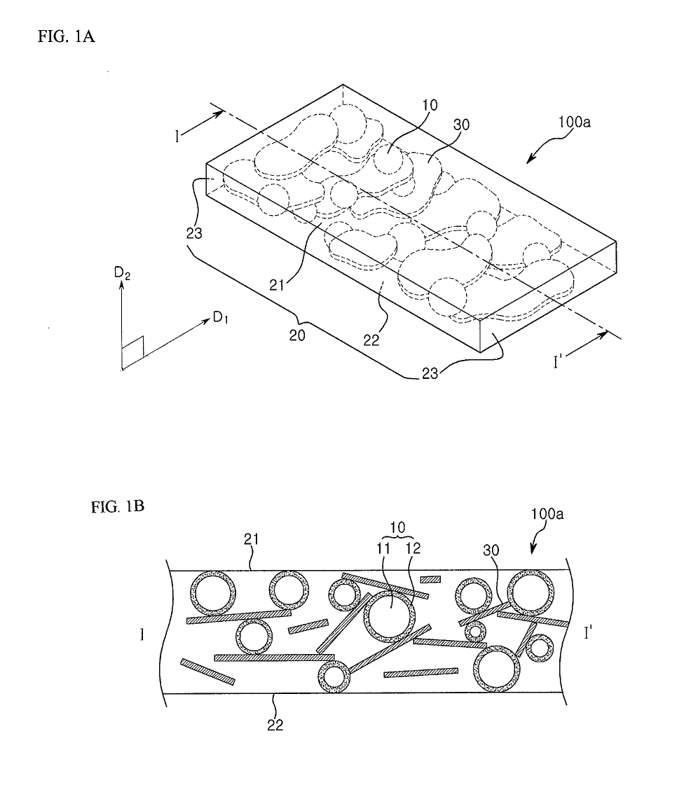

A thermally conductive particle includes a core and a metal layer. The more detailed description will be described below with reference to FIGS. 1 to 3. In addition, the relationship between the carbon-containing powder and the thermally conductive particle in the sheet will be described below in detail with reference to FIGS. 1 to 3.

Meanwhile, in the composition, the content of the thermally conductive particles may be about 1 wt % to about 30 wt % with respect to the total weight of the composition. Furthermore, the content of the carbon-containing powder may be about 1 to about 30 wt % with respect to the total weight of the composition. For example, when the contents of the thermally conductive particles and the carbon-containing powder are each less than 1 wt %, in the sheet manufactured by using the composition, there is few or no part in which the thermally conductive particles are brought into contact with the carbon-containing powder, so that heat transfer characteristics of the sheet may be hardly exhibited. In contrast, when the contents of the thermally conductive particles and the carbon-containing powder each exceed about 30 wt %, it may be difficult for the thermally conductive particles and the carbon-containing powder to be uniformly dispersed in the base resin.

The cross-linker may include an isocyanate-based compound, an epoxy-based compound, a melamine-based compound or an organic peroxide, and the like. These may be used either alone or in combination of two or more thereof.

The content of the cross-linker may be about 0 wt % to about 15 wt % with respect to the total weight of the composition. When the composition further includes the cross-linker, it is possible to manufacture a cured product including a densely cross-linked base resin as compared to the case of obtaining a cured product by simply drying the composition. However, when the content of the cross-linker exceeds about 15 wt %, because the content of at least one of the base resin, the thermally conductive particles, and the carbon-containing powder is relatively decreased, it is preferred that the composition includes about 15 wt % or less of the cross-linker so as not to affect the content of the other components.

The solvent may include ethyl acetate, methyl ethyl ketone, methylene chloride, tetrahydrofuran or chloroform, and the like. These may be used either alone or in combination of two or more thereof.

The content of the solvent is substantially the same as that of the others except for the total weight of the base resin, the thermally conductive particles, the carbon-containing powder, and the cross-linker, with respect to the total weight of the composition. The content of the solvent may be about 15 wt % to about 68 wt % with respect to the total weight of the composition.

The sheet may be easily manufactured through a drying process of evaporating the solvent by using the composition according to the present invention, which is described above. The composition may further include monomers including a thermally reactive functional group in addition to the constituent components described above. During the drying process of the composition, polymerization among the monomers occurs, or a cured product having a dense structure may be manufactured by a reaction between the base resin and the monomer.

FIG. 1 is a view illustrating a sheet according to the Example of the present invention. In FIG. 1, (a) is a perspective view for describing the sheet, and (b) is an enlarged cross-sectional view of the case in which the sheet is cut along line I-I′ of (a).

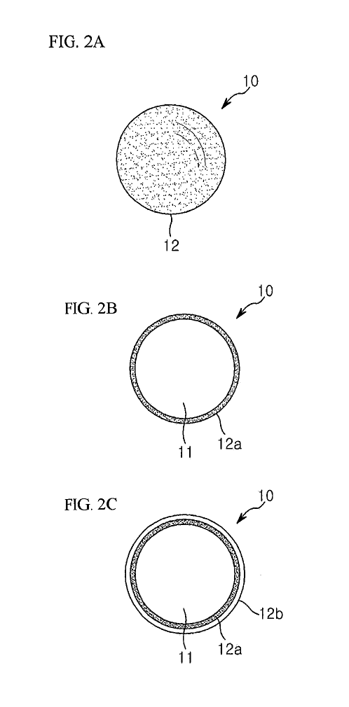

FIG. 2 is a view illustrating thermally conductive particles according to exemplary embodiments of the present invention. In FIG. 2, (a) is a perspective view of a thermally conductive particle, (b) is a cross-sectional view of a thermally conductive particle according to an exemplary embodiment, and (c) is a cross-sectional view of a thermally conductive particle according to a modified form of (b).

Referring to FIGS. 1 and 2, a sheet 100a according to the Example of the present invention includes a base film 20, a thermally conductive particle 10, and a carbon-containing powder 30.

The base film 20 includes a first surface 21, a second surface 22, and side surfaces 23. The first surface 21 and the second surface 22 face each other, and are connected to each other by the side surfaces 23.

The base film 20 includes a resin. In this case, the “resin” contained in the base film 20 may be a base resin in a solid state. On the contrary, when the sheet 100a is manufactured by using a composition further including a cross-linker, the base film 20 may include a cured product which is a cross-linked base resin. Since the base resin is substantially the same as the base resin included in the composition, an overlapping specific description thereof will be omitted. Specific examples of the base resin forming the base film 20 include an ethylene resin, a propylene resin, a vinyl chloride resin, a styrene resin, a carbonate resin, an ester resin, a nylon resin, a silicone resin or an imide resin, and the like. These may be used either alone or in combination of two or more thereof. The base film 20 may also include a cured product in which at least one resin exemplified above is cross-linked by a cross-linker.

Since the sheet 100a according to the present invention includes the base film 20 containing a resin unlike a metal heat radiation sheet, the weight thereof may be decreased.

The “in-plane direction” of the sheet 100a used below means an elongated direction D1 of a virtual line connecting any two points on any one surface of the first surface 21 and the second surface 22, which is a main surface of the sheet 100a. The “perpendicular direction” is defined as a direction perpendicular to the in-plane direction, that is, a direction D2 normal to the first surface 21 or the second surface 22.

The thermally conductive particle 10 and the carbon-containing powder 30 are distributed in the base film 20. The thermally conductive particle 10 includes a core 11 composed of a polymer and a metal layer 12 coated on the surface of the core 11.

The core 11 is a particle formed of a polymer, and serves as a substrate for forming the metal layer 12. Since the core 11 is formed of a polymer, it is easy to precisely control the size or shape of the core 11. Since the core 11 is formed of a polymer having a density lower than that of metal, the thermally conductive particle 10 may be precipitated in the base resin during the process of manufacturing the sheet 100a, thereby preventing the particles from being concentrated in the vicinity of the first surface 21 or the second surface 22 of the sheet 100a. Accordingly, it is possible to uniformly distribute the thermally conductive particle 10 in the base resin during the process of manufacturing the sheet 100a.

The core 11 may be spherical. However, the surface of the core 11 may not be exactly spherical. That is, even though the distance from the center of gravity of the core 11 to the surface thereof is not constant, a three-dimensional shape which may be classified as “substantially spherical” may also be typically defined as being spherical. On the contrary, the core 11 may also have a three-dimensional shape in which the distances from the center of gravity of the particle to the surface thereof are different, for example, an egg-shape.

The core 11 may have a diameter of about 300 nm to about 30 μm. The diameter of the core 11 is a straight-line distance between two points on the surface of the core 11, and is the length of a virtual straight line which connects the two points while passing through the center of gravity of the core 11. However, when the surface of the core 11 is curved or the straight-line distance varies according to the position of the two points, such as the egg-shape, the diameter of the core 11 means a maximum value of the straight-line distances. The sheet 100a includes a plurality of thermally conductive particles 10, and the diameters of the thermally conductive particles 10 included in one sheet 100a may be different from each other.

When the diameter of the core 11 is about 300 nm to about 30 μm, it is easy to control the shape of the core 11, and the metal layer 12 may be uniformly coated in a predetermined thickness on the surface of the core 11 manufactured. Accordingly, the manufacturing reliability of the thermally conductive particle 10 may also be improved. For example, when a core having a diameter of less than about 300 nm is manufactured, it is difficult to manufacture the cores 11 having a predetermined size even under the same manufacturing process conditions, and the cores 11 may be easily aggregated. Furthermore, even when the diameter of the core 11 exceeds about 30 μm, it is difficult to manufacture the plurality of cores 11 having a predetermined size, the thermally conductive particle 10 including the core 11 has low dispersibility with respect to a resin in the process of manufacturing the sheet 100a, and a precipitation phenomenon may easily occur.

Examples of the polymer which forms the core 11 include polystyrene, polymethyl methacrylate or an amino resin, and the like. These may be used either independently or in combination of two or more thereof. In consideration of easiness of controlling the size or shape of the core 11, the core 11 may be formed of polystyrene.

The metal layer 12 is formed on the surface of the core 11. Heat transfer characteristics of the thermally conductive particle 10 may be improved by the metal layer 12 having thermal conductivity higher than that of the core 11.

Referring to FIG. 2(b), the metal layer 12 may include a single layer 12a. The single layer 12a may be a single metal layer composed of one metal, and may further include a doped non-metal.

Examples of the metal which forms the single metal layer include gold (Au), silver (Ag), a nickel-phosphorus alloy (Ni—P alloy), a nickel-boron alloy (Ni—B alloy), beryllium (Be), chromium (Cr), zirconium (Zr), copper (Cu), cobalt (Co), aluminum (Al), magnesium (Mg), rhodium (Rh), zinc (Zn), tantalum (Ta), iron (Fe), titanium (Ti), platinum (Pt), tungsten (W), molybdenum (Mo), manganese (Mn), iridium (Ir) or tin (Sn), and the like. The nickel-phosphorus alloy or the nickel-boron alloy is an alloy of a metal and a non-metal, and may also be an alloy in which nickel (Ni) is doped with a predetermined content of phosphorus (P) or boron (B). In this case, the content of phosphorus (P) or boron (B) may be about 5 wt % to about 15 wt % with respect to the total weight of the metal layer 12.

Meanwhile, the single layer 12a may be an alloy metal layer including at least two or more of the metals exemplified above.

Referring to FIG. 2(c), the metal layer 12 may be a plurality of layers including at least two or more single layers 12a and 12b. Since the single layers 12a and 12b illustrated in FIG. 2(c) may be each independently a single metal layer or an alloy metal layer as in the single layer 12a described in FIG. 2(b), the overlapping specific description will be omitted. Even though not illustrated in the drawing, the plurality of layers may be a multiple layer including three or more layers.

The metal layer 12 may be coated in a thickness of about 50 nm to about 3 μm on the core 11. The thickness of the metal layer 12 may be defined as an average value of the distances from the surface of the core 11 to the surface of the metal layer 12. For example, when the metal layer 12 includes the single layer 12a, the single layer 12a may have a thickness of 50 nm to 3 μm. Further, when the metal layer 12 is a plurality of layers including the plurality of single layers 12a and 12b, the sum of the thicknesses of the single layers 12a and 12b may be about 50 nm to about 3 μm.

For example, when the metal layer 12 has a thickness of less than about 50 nm, the thickness of the metal layer 12 is so thin that it may be difficult for the thermally conductive particle 10 to have heat transfer characteristics. In addition, when the metal layer 12 has a thickness of more than about 3 μM, it is difficult to uniformly coat the surface of the core 11 with the metal layer 12, and the thermally conductive particle 10 may be easily precipitated in the resin by the weight of the metal layer 12 in the process of manufacturing the sheet 100a.

Meanwhile, as illustrated in FIG. 2(c), when the metal layer 12 is a plurality of layers, a first metal layer, which is the single layer 12a brought into direct contact with the core 11, may include a metal which may be easily coated on the core 11 formed of a polymer. For example, the first metal layer may include nickel (Ni), copper (Cu), cobalt (Co), silver (Ag), a nickel-phosphorus alloy (Ni—P alloy) or a nickel-boron alloy (Ni—B alloy), and the like. These may be used either independently or in combination of two or more thereof.

Furthermore, a second metal layer which is the single layer 12b formed on the first metal layer may include a metal having high thermal conductivity while being easily coated on the first metal layer. The metal constituting the second metal layer may substantially determine heat transfer characteristics of the thermally conductive particle 10. The second metal layer may include aluminum (Al), beryllium (Be), chromium (Cr), copper (Cu), gold (Au), molybdenum (Mo), nickel (Ni), zinc (Zn), rhodium (Rh), zirconium (Zr), silver (Ag) or tungsten (W), and the like. These may be used either alone or in combination of two or more thereof. As the metal which forms the second metal layer, a metal different from a metal which forms the first metal layer is selected.

The carbon-containing powder 30 illustrated in FIG. 1 is substantially the same as the carbon-containing powder included in the composition described above. Therefore, the overlapping specific description thereof will be omitted.

As an example, since graphene has a 2-dimensional plate-like structure, the heat transfer route in the graphene is substantially the same as the in-plane direction thereof. Heat is transferred even in a direction perpendicular to the in-plane direction of graphene, but the heat transfer is very minimal as compared to the degree that heat is transferred in the in-plane direction of graphene, so that the heat transfer route of graphene is substantially the same as the in-plane direction thereof. In this case, the in-plane direction of graphene may be substantially the same as the in-plane direction of the sheet 100a, or may be inclined at a predetermined angle θ₁. The predetermine angle θ₁ may be about −60° to +60° based on the first surface 21 or the second surface 22. That is, the interplanar angle between the basal plane of graphene and the first surface 21 or the second surface 22 may be about −60° to +60°. In this case, thermal conductivity of the sheet 100a in the in-plane direction thereof may be about 200 W/mK to about 500 W/mK. The thermal conductivity of the sheet 100a may be measured by LFA-457 (trade name) manufactured by NETZSCH Inc.

Meanwhile, the thermally conductive particle 10 may be brought into contact with the carbon-containing powder 30, thereby improving heat transfer characteristics in the perpendicular direction. At least a part of the thermally conductive particle 10 may be interposed between the carbon-containing powders 30, so that the carbon-containing powders 30 may be indirectly connected to each other through the thermally conductive particle 10. In this case, the heat transfer route in the perpendicular direction may be substantially the same as the normal direction D2, or may be the same as a direction inclined at a predetermined angle θ₂. The predetermined angle θ₂ may be −30° to +30° based on the normal direction D2. In this case, the thermal conductivity of the sheet 100a in the perpendicular direction thereof may be variously adjusted to about 3 W/mK to about 50 W/mK according to the contents of the thermally conductive particle 10 and the carbon-containing powder 30, but in the present invention, it is preferred that the heat conductivity of the sheet 100a in the perpendicular direction thereof is adjusted to at least about 10 W/mK to about 20 W/mK.

Simultaneously, the thermally conductive particle 10 may be brought into contact with the carbon-containing powder 30, thereby further improving even heat transfer characteristics in the in-plane direction.

In the sheet 100a, the content of the thermally conductive particle 10 may be about 1 wt % to about 30 wt % with respect to the total weight of the sheet 100a. Further, the content of the carbon-containing powder 30 may be about 1 wt % to about 30 wt % with respect to the total weight of the sheet 100a.

As an example, when the contents of the thermally conductive particle 10 and the carbon-containing powder 30 are each less than 1 wt %, there is few or no part in which the thermally conductive particle 10 is brought into contact with the carbon-containing particle 30, so that heat transfer characteristics in the perpendicular direction by the thermally conductive particle 10 may not be exhibited. In contrast, when the contents of the thermally conductive particle 10 and the carbon-containing powder 30 each exceed about 30 wt %, it is difficult for the thermally conductive particle 10 and the carbon-containing powder 30 to be uniformly dispersed throughout in the sheet 100a.

In addition, the content of the metal layer 12 may be about 0.5 wt % to about 70 wt % with respect to the total weight of the thermally conductive particle 10, that is, the sum weight of the core 11 and the metal layer 12. For example, when the content of the metal layer 12 of the thermally conductive particle 10 is less than about 0.5 wt %, heat transfer characteristics of the sheet 100a in the perpendicular direction thereof may be hardly exhibited. Furthermore, when the content of the metal layer 12 of the thermally conductive particle 10 exceeds about 70 wt %, the content of the metal layer 12 having a density larger than that of the core 11 is increased in the thermally conductive particle 10, so that when the sheet 100a is manufactured, precipitation may occur in the base resin, thereby leading to deterioration in dispersibility.

As described above, heat transfer characteristics of the sheet 100a in the in-plane direction as well as in the vertical direction may be improved by the thermally conductive particle 10 and the carbon-containing power 30.

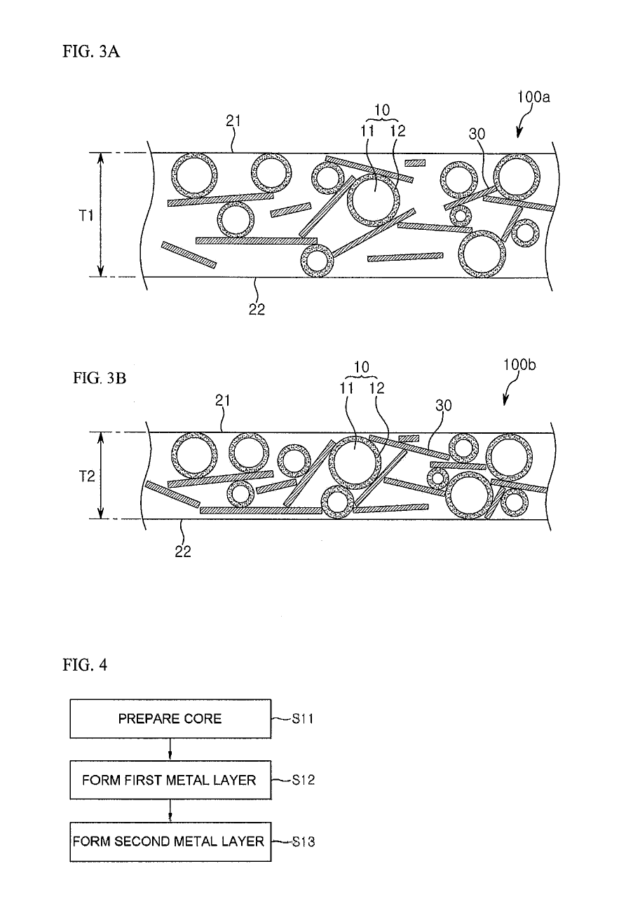

FIG. 3 is a view illustrating a sheet according to the modified Example of the present invention. In FIG. 3, (a) is a partial cross-sectional view of a sheet manufactured without compression, and (b) is a partial cross-sectional view of a compressed sheet.

A sheet 100a illustrated in FIG. 3(a) is substantially the same as the sheet 100a described in FIGS. 1 and 2, and a sheet 100b illustrated in FIG. 3(b) is substantially the same as the sheet 100a described in FIGS. 1 and 2, except for the arrangement of the thermally conductive particle 10 and the carbon-containing powder 30. Therefore, the overlapping detailed description thereof will be omitted.

Referring to FIG. 3(b), the compressed sheet 100b includes a base film 20, a thermally conductive particle 10, and a carbon-containing powder 30. The sheet 100b has a second thickness T2 smaller than a first thickness T1 of the sheet 100a manufactured without compression.

When the surface areas of the first surfaces 21 of the sheets 100a and 100b are the same as each other, the distance between the thermally conductive particle 10 and the carbon-containing powder 30 in the sheet 100b having the second thickness T2 is relatively closer than the distance between the thermally conductive particle 10 and the carbon-containing powder 30 in the sheet 100a having the first thickness T1. In addition, the distance between the thermally conductive particles 10 or the distance between the carbon-containing powders 30 in the sheet 100b illustrated in FIG. 3(b) is closer than that in the sheet 100a illustrated in FIG. 3(a). Accordingly, the heat conductivity of the compressed sheet 100b may be improved as compared to the thermal conductivity of the sheet 100a manufactured without compression.

As described above, considering that as the distance between the thermally conductive particles 10, the distance between the carbon-containing powders 30, or the distance between the thermally conductive particle 10 and the carbon-containing powder 30 becomes close, heat may be easily transferred, the sheet 100b may be manufactured by performing a compression process.

Hereinafter, a method for manufacturing the thermally conductive particle 10 and a method for manufacturing the sheets 100a and 100b will be described.

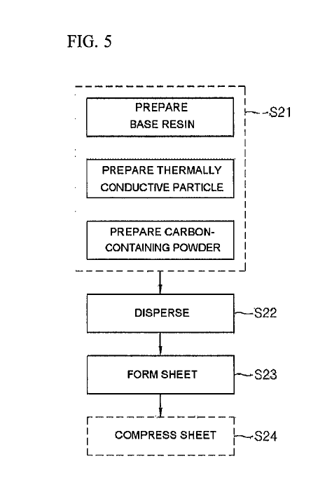

FIG. 4 is a view sequentially illustrating a method for manufacturing a thermally conductive particle according to an exemplary embodiment of the present invention.

Referring to FIG. 4, a core 11 composed of a polymer is prepared (Step S11).

The core 11 may have a diameter of about 300 nm to about 30 μm. For example, the core 11 may be formed of polystyrene, polymethyl methacrylate or an amino resin, and the like. These may be used either alone or in combination of two or more thereof.

A first metal layer is formed on the surface of the core 11 (Step S12).

For example, the first metal layer may be formed on the surface of the core 11 by using an electroless plating method. The first metal layer may be formed by using a reduction plating method as the plating method. On the contrary, the first metal layer may be formed by using non-catalytic plating, autocatalytic plating, and the like as the plating method. Since a specific content on the first metal layer is substantially the same as that described in FIG. 2(c), the overlapping detailed description thereof will be omitted.

A second metal layer is formed on the surface of the first metal layer (Step S13).

The second metal layer may be formed on the first metal layer by using a substitution plating method due to the difference in oxidation/reduction strength between different metals.

The thermally conductive particle 10 illustrated in FIG. 2(c) may be manufactured by forming the second metal layer on the surface of the first metal layer.

Even though not described in FIG. 4, the thermally conductive particle 10 illustrated in FIG. 2(b) may be manufactured by omitting the step of forming the second metal layer. In this case, the thickness of the first metal layer of the thermally conductive particle 10 illustrated in FIG. 2(b) is larger than the thickness of the first metal layer of the thermally conductive particle 10 illustrated in FIG. 2(c). That is, the thermally conductive particle 10 may be manufactured while the thickness of the first metal layer of the thermally conductive particle 10 illustrated in FIG. 2(b) is controlled so as to be substantially the same as the total thickness of the first metal layer and the second metal layer of the thermally conductive particle 10 illustrated in FIG. 2(c).

FIG. 5 is a view for describing a method for manufacturing a sheet according to the Examples of the present invention.

Referring to FIG. 5, first, a base resin, a thermally conductive particle 10, and a carbon-containing powder 30 are each prepared (Step S21).

The base resin may be prepared by being dissolved in a solvent. Since the base resin and the solvent are each substantially the same as those described above on the composition according to the present invention, the overlapping specific description thereof will be omitted.

Since the thermally conductive particle 10 is the same as that described in FIGS. 1 and 2, the overlapping description thereof will be omitted. The thermally conductive particle 10 may be prepared by forming the metal layer 12 on the surface of the core 11. When the thermally conductive particle 10 includes the first and second metal layers, the thermally conductive particle 10 may be manufactured by a method substantially the same as the method described in FIG. 4.

Subsequently, the thermally conductive particle 10 and the carbon-containing powder 30 are dispersed in the base resin (Step S22).

For example, the thermally conductive particle 10 and the carbon-containing powder 30 are mixed in the base resin, and the thermally conductive particle 10 and the carbon-containing powder 30 are dispersed in the base resin by using a vortex mixer. In this case, the thermally conductive particle 10 and the carbon-containing powder 30 may be dispersed in the base resin by a method such as a mechanical stirrer, a homogenizer, sonication, or milling, instead of the vortex mixer. A composition including the base resin in which the thermally conductive particle 10 and the carbon-containing powder 30 are dispersed may be a raw material for a sheet, and may be traded as a commercial product itself.

A sheet is formed by using the composition thus prepared (Step S23).

The sheet according to the present invention may be manufactured by coating the composition in a predetermined thickness on a material to be coated, and drying the coated composition. For example, the sheet may be manufactured by performing a drying process on the coated composition at high temperature, and then decreasing the temperature to room temperature. During the drying process or before the drying process, a process of applying pressure on the coated composition may be added.

As described above, the detailed description of the present invention has described specific examples, but the present invention is not limited thereto, and is limited by the claims to be described below. Therefore, the present invention may be variously changed and modified by a person with ordinary skill in the art without departing from the technical spirit of the claims to be described below.

1. A composition comprising:
a base resin;
thermally conductive particles distributed in the base resin; and
a carbon-containing powder distributed in the base resin.

2. The composition of claim 1, wherein the thermally conductive particle comprises:
a core; and
a metal layer coated on a surface of the core.

3. The composition of claim 2, wherein the metal layer comprises a single layer or a plurality of layers.

4. The composition of claim 2, wherein the metal layer comprises at least one of gold (Au), silver (Ag), a nickel-phosphorus alloy (Ni—P alloy), a nickel-boron alloy (Ni—B alloy), beryllium (Be), chromium (Cr), zirconium (Zr), copper (Cu), cobalt (Co), aluminum (Al), magnesium (Mg), rhodium (Rh), zinc (Zn), tantalum (Ta), iron (Fe), titanium (Ti), platinum (Pt), tungsten (W), molybdenum (Mo), manganese (Mn), iridium (Ir), and tin (Sn).

5. The composition of claim 2, wherein the metal layer has a thickness of 50 nm to 3 μm.

6. The composition of claim 2, wherein a content of the metal layer is 0.5 to 70 wt % with respect to a total weight of the core and the metal layer.

7. The composition of claim 2, wherein the core comprises a polymer.

8. The composition of claim 2, wherein the core is spherical, and the core has a diameter of 300 nm to 30 μm.

9. The composition of claim 1, wherein the base resin comprises at least one selected from an ethylene resin, a propylene resin, a vinyl chloride resin, a styrene resin, a carbonate resin, a urethane resin, an ester resin, a nylon resin, a silicone resin, and an imide resin.

10. The composition of claim 1, wherein the carbon-containing powder comprises at least one of carbon nanotubes, graphene flake, oxidized graphene flake, graphite flake, expanded graphite flake, oxidized graphite flake, fullerene, carbon fiber, and carbon black.

11. The composition of claim 10, wherein the graphene flake has a specific surface area of 50 m²/g to 2,675 m²/g.

12. The composition of claim 1, wherein a content of the thermally conductive particles is 1 to 30 wt % with respect to a total weight of the composition.

13. The composition of claim 1, wherein a content of the carbon-containing powder is 1 to 30 wt % with respect to a total weight of the composition.

14. The composition of claim 1, further comprising:
an extra solvent,
wherein a content of the base resin is 30 to 65 wt %, a content of the thermally conductive particles is 1 to 30 wt %, and a content of the carbon-containing powder is 1 to 30 wt %, with respect to a total weight of the composition.

15. A sheet conducting heat, comprising:
a base film;
thermally conductive particles distributed in the base film; and
a carbon-containing powder distributed in the base film.

16. The sheet of claim 15, wherein a surface of a core of the thermally conductive particle is coated with a metal layer.

17. The sheet of claim 15, wherein at least a part of the thermally conductive particles are brought into contact with the carbon-containing powder.

18. The sheet of claim 16, wherein the metal layer comprises a single layer or a plurality of layers.

19. The sheet of claim 18, wherein in the plurality of layers, layers comprising different metals are laminated.

20. The sheet of claim 16, wherein the metal layer comprises at least one of gold (Au), silver (Ag), a nickel-phosphorus alloy (Ni—P alloy), a nickel-boron alloy (Ni—B alloy), beryllium (Be), chromium (Cr), zirconium (Zr), copper (Cu), cobalt (Co), aluminum (Al), magnesium (Mg), rhodium (Rh), zinc (Zn), tantalum (Ta), iron (Fe), titanium (Ti), platinum (Pt), tungsten (W), molybdenum (Mo), manganese (Mn), iridium (Ir), and tin (Sn).

21. The sheet of claim 16, wherein the metal layer has a thickness of 50 nm to 3 μm.

22. The sheet of claim 16, wherein with respect to a total amount of the core and the metal layer, a content of the metal layer is 0.5 wt % to 70 wt %.

23. The sheet of claim 16, wherein the core comprises a polymer.

24. The sheet of claim 16, wherein the core is spherical, and the core has a diameter of 300 nm to 30 μm.

25. The sheet of claim 23, wherein the polymer comprises at least one of polystyrene, polymethyl methacrylate, and an amino resin.

26. The sheet of claim 15, wherein the base film comprises at least one of an ethylene resin, a propylene resin, a vinyl chloride resin, a styrene resin, a carbonate resin, a urethane resin, an ester resin, a nylon resin, a silicone resin, and an imide resin.

27. The sheet of claim 15, wherein the carbon-containing powder comprises at least one of carbon nanotubes, graphene flake, oxidized graphene flake, graphite flake, expanded graphite flake, oxidized graphite flake, fullerene, carbon fiber, and carbon black.

28. The sheet of claim 27, wherein the graphene flake comprises graphene comprising at least one layer or more.

29. The sheet of claim 27, wherein the graphene flake has a specific surface area of 50 m²/g to 2,675 m²/g.

30. The sheet of claim 15, wherein a content of the thermally conductive particles is 1 to 30 wt % with respect to a total weight of the sheet.

31. The sheet of claim 15, wherein a content of the carbon-containing powder is 1 to 30 wt % with respect to a total weight of the sheet.

32. The sheet of claim 15, wherein the sheet has heat conductivity of 3 W/mK to 50 W/mK in a direction perpendicular to an in-plane direction.
